(19) United States
(12) Patent Application Publication
(10) Pub. No.: US 2024/0198589 A1
(43) Pub. Date: Jun. 20, 2024

(54) Loop Variable Timer For Additive Manufacturing

(71) Applicant: Seurat Technologies, Inc., Wilmington, MA (US)

(72) Inventors: Ian Doyle, Londonderry, NH (US); Robbert van der Bijl, Deerfield, NH (US); Andrew J. Bayramian, Marblehead, MA (US); Jeffrey Jarboe, Wakefield, MA (US); James A. DeMuth, Woburn, MA (US)

(21) Appl. No.: 18/539,522

(22) Filed: Dec. 14, 2023

Related U.S. Application Data
(60) Provisional application No. 63/387,617, filed on Dec. 15, 2022.

(51) Int. Cl. B29C 64/268; B29C 64/153; B29C 64/236

(52) U.S. Cl. CPC B29C 64/268; B29C 64/153; B29C 64/236; B33Y 30/00

(57) ABSTRACT

A print engine of an additive manufacturing system can include an XY galvo arranged to direct a laser beam toward multiple positions on a print bed following a print path. In one embodiment an XY gantry supporting the XY galvo is connected to a motion control system that supports dynamic adjustment of the cycle time for both the XY gantry and XY galvo.

### RELATED APPLICATION

The present disclosure is part of a non-provisional patent application claiming the priority benefit of U.S. Patent Application No. 63/387,617, filed on Dec. 15, 2022, which is incorporated by reference in its entirety.

### TECHNICAL FIELD

The present disclosure generally relates to a system and method for powder bed preparation for high throughput additive manufacturing. In one embodiment, high speed manufacturing is supported by use a pulsed laser controller that synchronizes with a process system controller and allows the timing of laser pulses to be scheduled within a range of allowed frequencies based on real-time process feedback.

### BACKGROUND

Traditional component machining often relies on removal of material by drilling, cutting, or grinding to form a part. In contrast, additive manufacturing, also referred to as 3D printing, typically involves sequential layer by layer addition of material to build a part. Beginning with a 3D computer model, an additive manufacturing system can be used to create complex parts from a wide variety of materials.

One additive manufacturing technique known Powder Bed Fusion Additive Manufacturing (PBF-AM) uses one or more focused lasers to draw a pattern in a thin layer of powder by melting the powder and bonding it to the layer below to gradually form a 3D printed part. Powders can be plastic, metal, glass, ceramic, crystal, other meltable material, or a combination of meltable and unmeltable materials (i.e. plastic and wood or metal and ceramic).

Often, pulse lasers with a fixed clock generated by a laser control system are used. Typically, clock timing can be varied or shifted when not printing, but to maintain high quality laser pulses while printing the frequency and phase should not change significantly. In practice, this means that the laser control system will “skip” a cycle if the motion does not complete in the maximum time allotted.

To improve throughput and print quality what is needed is a method for dynamic cycle time adjustment. Advantageously, this can reduce cycle skips and improve speed and quality of powder bed printing.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1A illustrates an embodiment of a tile print process;

FIG. 1B illustrates a modified serpentine tile print path;

FIG. 1C illustrates offset tile overlap;

FIG. 1D illustrates a printer control system and laser control system that can control laser timing during tile printing;

FIG. 1E illustrates one embodiment of a laser heating cycle;

FIG. 1F illustrates top and side view for an XY gantry supporting a XY galvo mirror;

FIG. 2 illustrates XY gantry motion in two specific use cases;

FIG. 3 illustrates an additive manufacturing system able to provide one or two dimensional light beams to a cartridge

FIG. 4 illustrates a method of operating a cartridge based additive manufacturing system able to provide one or two dimensional light beams to a cartridge; and

FIG. 5 additive manufacturing system that includes a phase change light valve and a switchyard system enabling reuse of patterned two-dimensional energy.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

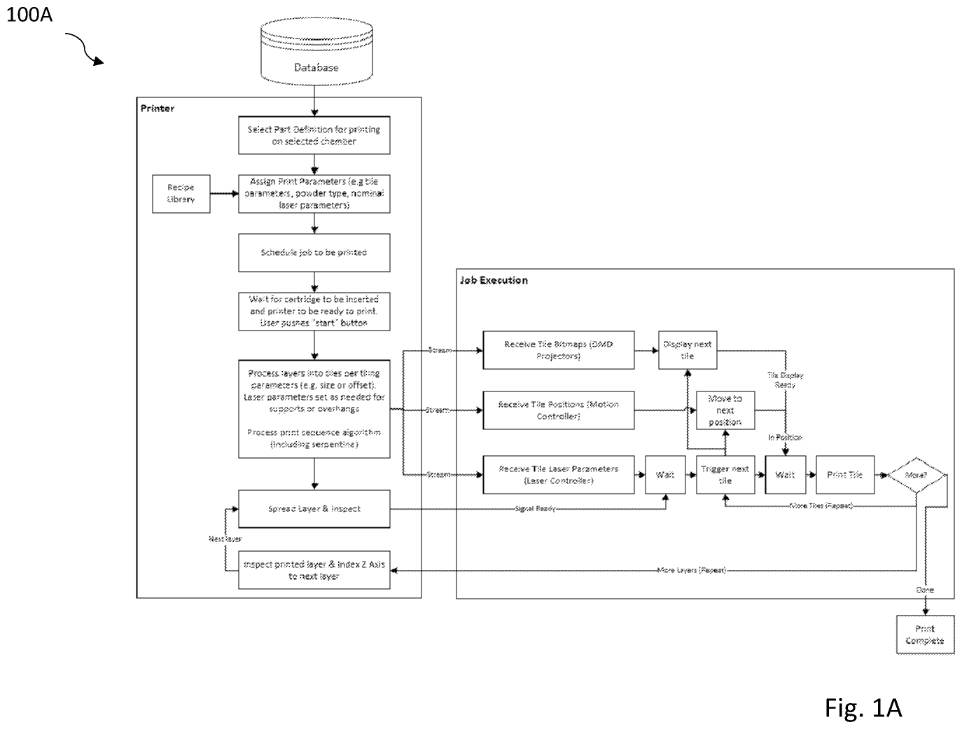

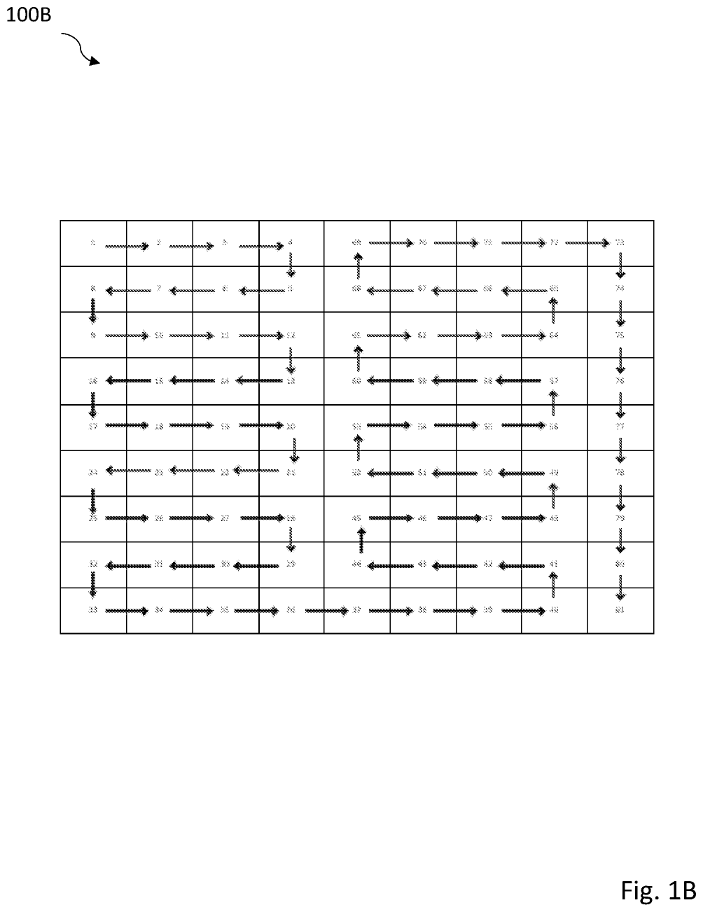

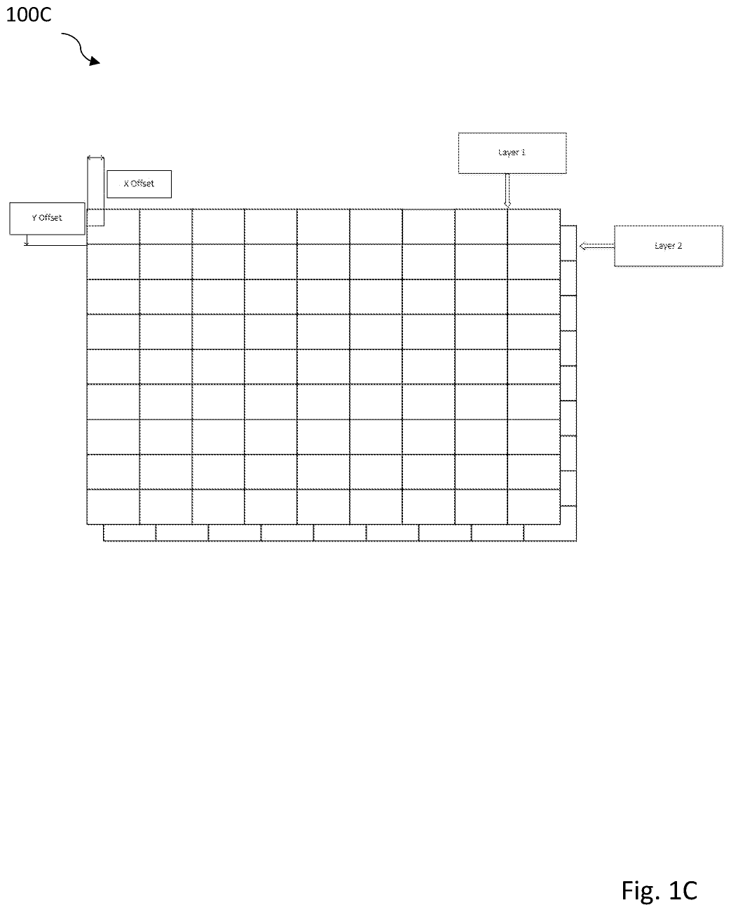

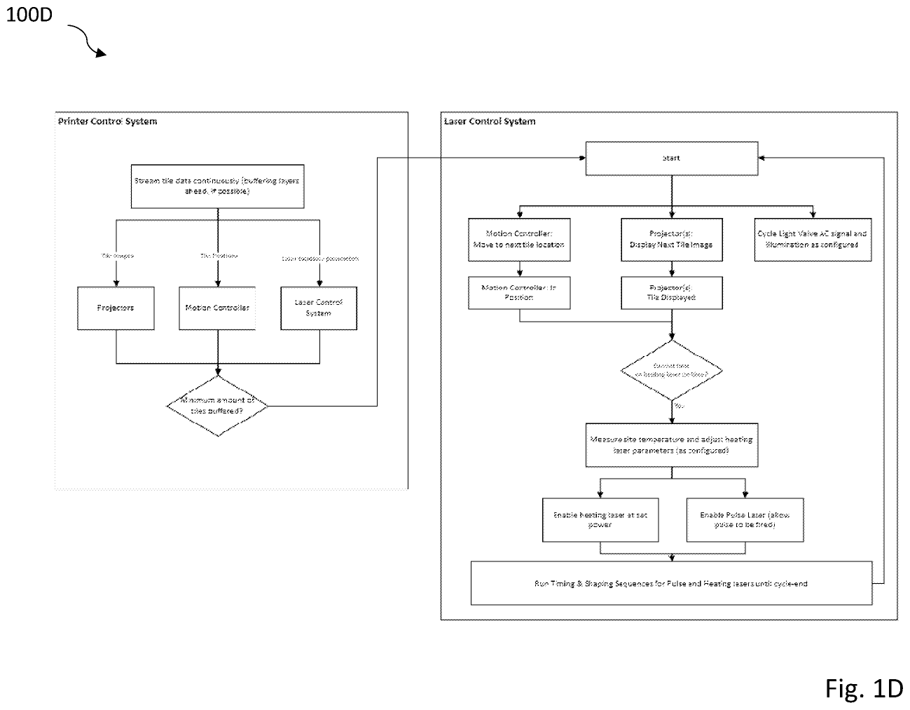

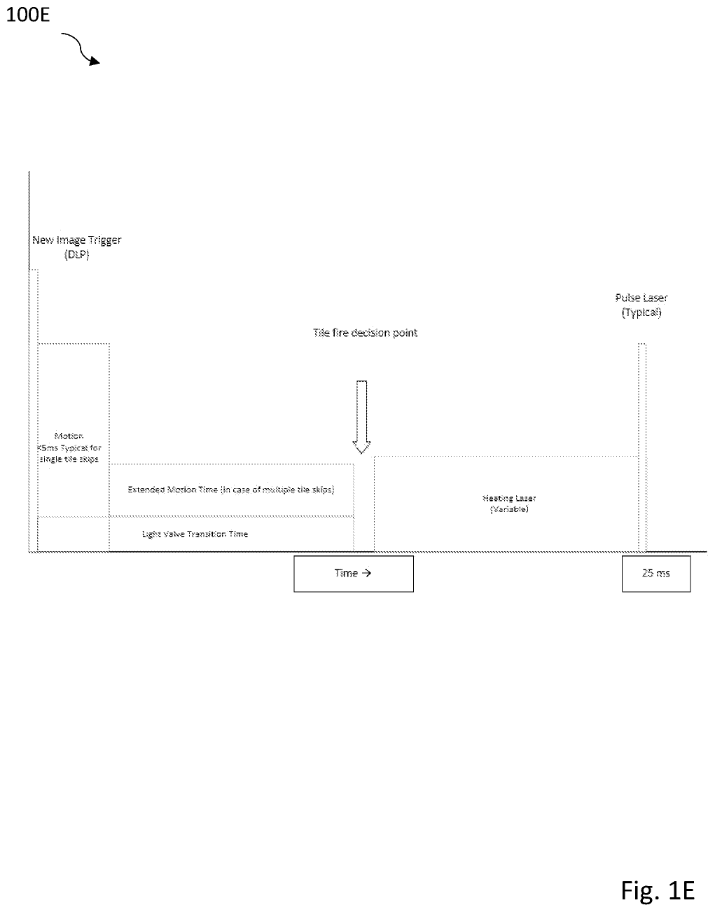

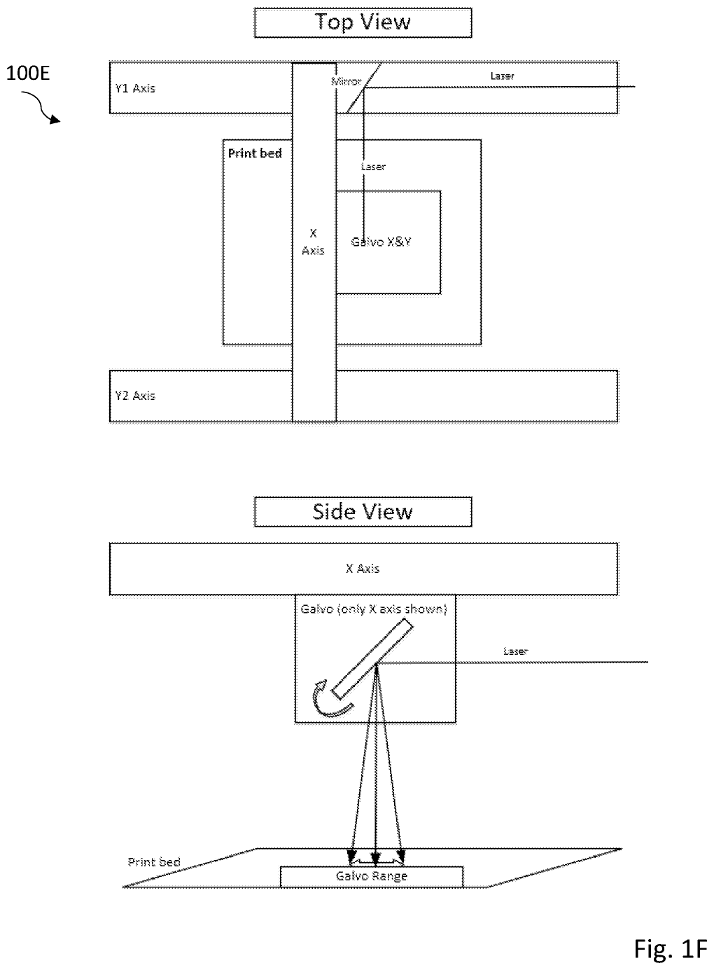

FIG. 1A illustrates an embodiment of a tile print process 100A. As seen in FIG. 1A, suitable software computer aided design (CAD) files that provide necessary details regarding printable part parameters and metadata can be stored in a database accessible by an additive manufacturing printer. In one process embodiment a part definition for printing in a chamber is selected. Using a recipe library, print parameters including tile parameters, powder type, or nominal laser parameters are assigned. A print job is scheduled and powder bed and optional cartridge system can be readied for printing. Once print is initiated, layers are processed to determine tiling parameters, including size and offset, with laser parameters set for compensating for supports or overhangs. A process print sequence algorithm, optionally including serpentine paths can be chosen and data streamed for job execution. Job execution can include spreading and inspecting a powder layer, receipt of tile bitmaps by projectors, receipt of tile positions by a motion controller, and receipt of tile laser parameters by a laser controller. During execution projectors are readied to display tiles, the laser controller prints the tile, and the motion controller moves between subsequent tile positions until completion of a print job. In some embodiments, each printed layer can be inspected and the Z-axis indexed for to the next layer.

FIG. 1B illustrates a modified tile print path 100B that shows an example print path for a rectangular print bed divided into 81 tiles. Print path moving from a tile to tile is indicated by arrows in FIG. 1B. Using tiling parameters such as tile size, tile offset, and width, various alternative print paths can also be arranged. In some embodiments, a print path can be arranged at least in part according to the pattern that is to be printed and/or the number of tiles able to be managed by a galvo mirror system. In one embodiment, a serpentine path such as seen with respect to print path 100B can be determined. This example serpentine path can be modified based on which tiles need to be printed and which tiles do not need to be printed. In some embodiments, a serpentine path can be shifted to start at a first corner of a first tile to be printed. In other embodiments, the path can be dynamically adjusted to minimize motion between tiles, or hybrid serpentine paths can be determined that accommodate other process or thermal constraints (e.g. allowing longer rest times for certain tiles to cool). In some embodiments, those tiles that do not need to be printed can be skipped, advantageously reducing required mechanical movement of galvo gantries and galvo mirrors as compared to embodiments that move to each and every tile position during a conventional linear or serpentine path that moves to every potential tile position.

FIG. 1C illustrates offset tile overlap 100C. Typically, overlap is a small fraction of tile size, and can be measured in microns to millimeters. In one embodiment, an x and a y offset with respect to an underlying layer are provided for a subsequent layer. In effect, this provides tile overlay and ensures that stitched seams do not overlap. In some embodiments, tile overlap can be set so that tiles can overlap in a same print layer, in addition to, or instead of, overlap between layers.

FIG. 1D illustrates a printer control system and laser control system 100D that can control laser timing during tile printing. As illustrated, streaming tile data for printing is continuously supplied to tile image projector, tile position motion controller, and a laser controller. In one embodiment, data streaming is structured so that the image projector and motion controller always have more queued data than the laser controller, ensuring that the image projector and motion controller have sufficient tile information to allow the laser controller to be triggered for upcoming tiles that need to be printed. In some embodiments, streaming is not real time, and requires buffering tile image projector, tile position motion controller, and a laser controller.

The printer control system passes data to the laser control system when a minimum amount of tile data is buffered. Light valve cycling and illumination can be configured, the motion controller moves optics and projector provides a display to illuminate a desired tile. Laser heating time is set, target site temperature measured, laser power set, and a pulse laser is enabled. The pulse laser can then be fired with various timing or shaping sequences as needed. In some embodiments cycle time can be adjusted to help avoid cycle skips.

FIG. 1E illustrates one embodiment of a loop variable timer for a laser timing and heating cycle 100E that is possible using a system and process such as described with respect to FIGS. 1A and 1D. As illustrated, in one embodiment a laser preparation and firing process can take place over a nominal 25 millisecond (40 Hz) cycle. A new image trigger can start process that include a single tile skip or in some cycles, extended movement for multiple tile skips. Concurrently, a light valve can transition to a new pattern. Once the light valve is ready and motion has stopped, the laser heating can be initialized to bring the powder temperature in the required pattern close to melting point, followed by triggering a laser pulse to fully melt powder in the required pattern. The cycle is then repeated until tile manufacture is complete for each layer. In some embodiments, dynamic cycle time adjustment within a certain tolerance may be possible (i.e. between 35 and 40 Hz). This can avoid some cycle skips, provided the average frequency for the pulse laser does not drop enough to cause thermal issues.

FIG. 1F illustrates top and side view for an XY gantry supporting a XY galvo mirror. In some embodiments, movements such as discussed with respect to FIGS. 1A, 1D, and 1E can include both XY galvo mirror movement and movement of the XY gantry supporting the XY galvo mirror. This embodiment can be used when XY galvo range is not sufficient to address an entire print bed. As seen in top view, a patterned or unpatterned laser beam can be directed by a fixed mirror toward the movable XY galvo mirror, which in turn directs the laser beam toward a print bed. Typically, the XY galvo mirror can be rotated 0.5 degrees in 5 milliseconds or less, which is much faster than XY gantry movement.

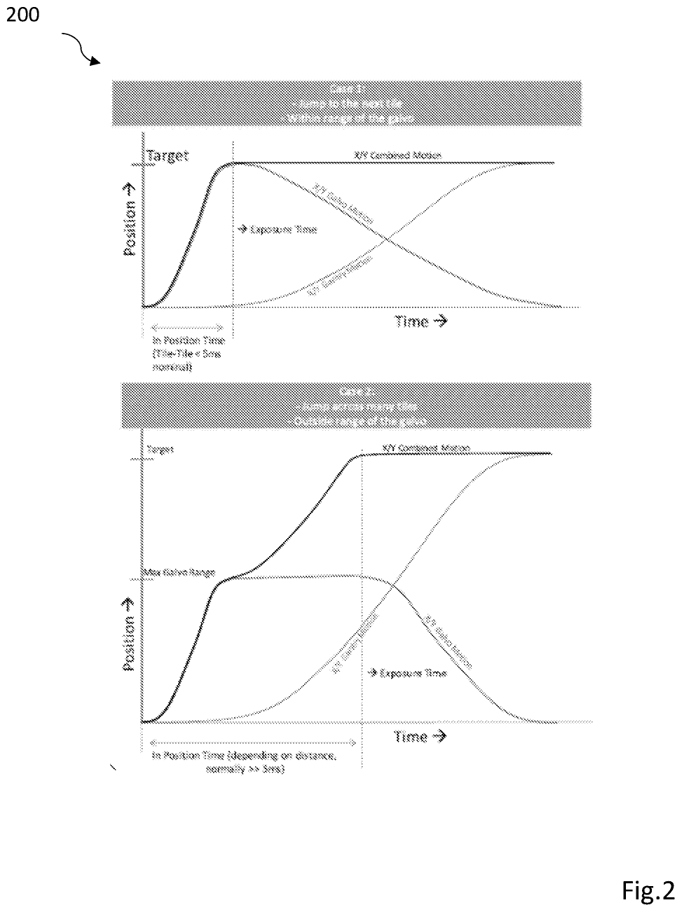

FIG. 2 illustrates XY gantry motion 200 in two specific use cases for an XY gantry supporting a XY galvo mirror such as discussed with respect to FIG. 1F. In one embodiment, an XY gantry is sent to a setpoint at a determined acceleration and velocity. A distance between the setpoint and actual XY gantry position is sent to the XY galvo. If this distance is within range of the XY galvo laser beam redirection, a tile target is in range and laser processing of a tile on a print can begin. This is illustrated with respect to Case 1 of FIG. 2. If this distance is not within range, the XY gantry is moved (or continues to move) until the XY galvo is within range, as seen with respect to Case 2 of FIG. 2. Note that in some embodiments, XY gantry motion does not need stop before laser processing begins. Also, in some embodiments new setpoint targets can be dynamically supplied to the XY gantry or XY galvo at any time.

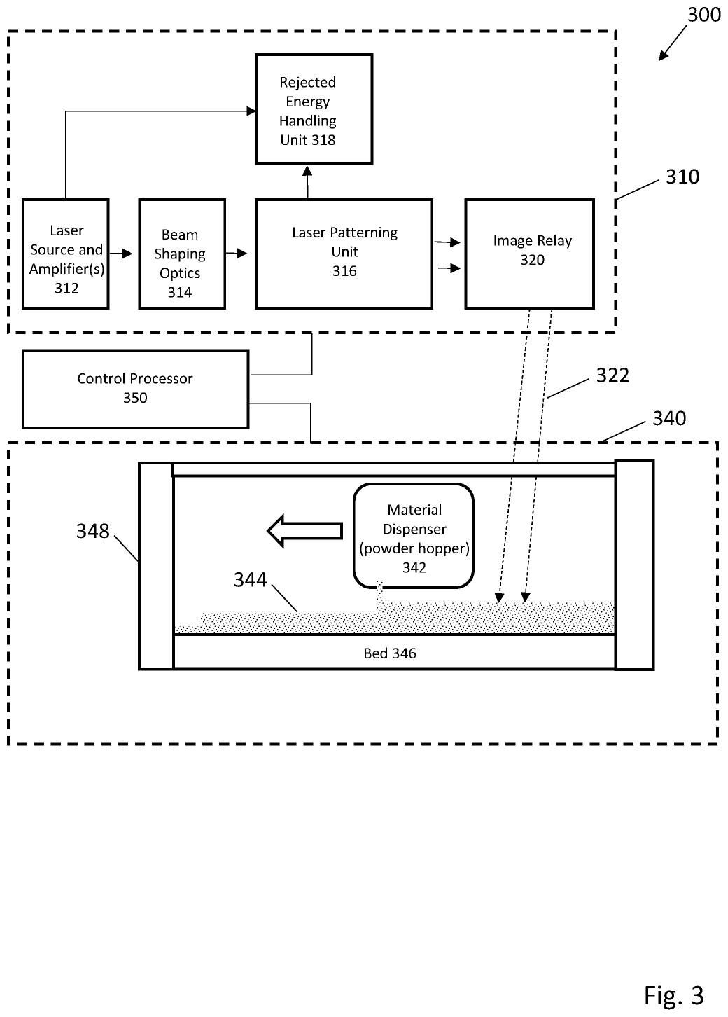

In an embodiment illustrated with respect to FIG. 3, additive manufacturing systems can be represented by various modules that form additive manufacturing method and system 300 suitable for use in conjunction with tile printing process procedures that can optionally use an XY galvo gantry and galvo mirror system with a loop variable timer. As seen in FIG. 3, a laser source and amplifier(s) 312 can be constructed as a continuous or pulsed laser. In other embodiments the laser source includes a pulse electrical signal source such as an arbitrary waveform generator or equivalent acting on a continuous-laser-source such as a laser diode. In some embodiments this could also be accomplished via a fiber laser or fiber launched laser source which is then modulated by an acousto-optic or electro optic modulator. In some embodiments a high repetition rate pulsed source which uses a Pockels cell can be used to create an arbitrary length pulse train.

Possible laser types include, but are not limited to: Gas Lasers, Chemical Lasers, Dye Lasers, Metal Vapor Lasers, Solid State Lasers (e.g. fiber), Semiconductor (e.g. diode) Lasers, Free electron laser, Gas dynamic laser, “Nickel-like” Samarium laser, Raman laser, or Nuclear pumped laser.

A Gas Laser can include lasers such as a Helium-neon laser, Argon laser, Krypton laser, Xenon ion laser, Nitrogen laser, Carbon dioxide laser, Carbon monoxide laser or Excimer laser.

A Chemical laser can include lasers such as a Hydrogen fluoride laser, Deuterium fluoride laser, COIL (Chemical oxygen-iodine laser), or Agil (All gas-phase iodine laser).

A Metal Vapor Laser can include lasers such as a Helium-cadmium (HeCd) metal-vapor laser, Helium-mercury (HeHg) metal-vapor laser, Helium-selenium (HeSe) metal-vapor laser, Helium-silver (HeAg) metal-vapor laser, Strontium Vapor Laser, Neon-copper (NeCu) metal-vapor laser, Copper vapor laser, Gold vapor laser, or Manganese (Mn/MnC₁₂) vapor laser. Rubidium or other alkali metal vapor lasers can also be used. A Solid State Laser can include lasers such as a Ruby laser, Nd:YAG laser, NdCrYAG laser, Er:YAG laser, Neodymium YLF (Nd:YLF) solid-state laser, Neodymium doped Yttrium orthovanadate (Nd:YVO₄) laser, Neodymium doped yttrium calcium oxoborateNd:YCa₄O(BO₃)₃ or simply Nd:YCOB, Neodymium glass (Nd:Glass) laser, Titanium sapphire (Ti:sapphire) laser, Thulium YAG (Tm:YAG) laser, Ytterbium YAG (Yb:YAG) laser, Ytterbium:₂O₃ (glass or ceramics) laser, Ytterbium doped glass laser (rod, plate/chip, and fiber), Holmium YAG (Ho:YAG) laser, Chromium ZnSe (Cr:ZnSe) laser, Cerium doped lithium strontium (or calcium)aluminum fluoride (Ce:LiSAF, Ce:LiCAF), Promethium 147 doped phosphate glass (147Pm+3:Glass) solid-state laser, Chromium doped chrysoberyl (alexandrite) laser, Erbium doped and erbium-ytterbium co-doped glass lasers, Trivalent uranium doped calcium fluoride (U:CaF₂) solid-state laser, Divalent samarium doped calcium fluoride (Sm:CaF₂) laser, or F-Center laser.

A Semiconductor Laser can include laser medium types such as GaN, InGaN, AlGaInP, AlGaAs, InGaAsP, GaInP, InGaAs, InGaAsO, GaInAsSb, lead salt, Vertical cavity surface emitting laser (VCSEL), Quantum cascade laser, Hybrid silicon laser, or combinations thereof.

As illustrated in FIG. 3, the additive manufacturing system 300 uses lasers able to provide one- or two-dimensional directed energy as part of an energy patterning system 310. In some embodiments, one dimensional patterning can be directed as linear or curved strips, as rastered lines, as spiral lines, or in any other suitable form. Two-dimensional patterning can include separated or overlapping tiles, or images with variations in laser intensity. Two-dimensional image patterns having non-square boundaries can be used, overlapping or interpenetrating images can be used, and images can be provided by two or more energy patterning systems. The energy patterning system 310 uses laser source and amplifier(s) 312 to direct one or more continuous or intermittent energy beam(s) toward beam shaping optics 314. After shaping, if necessary, the beam is patterned by an energy patterning unit 316, with generally some energy being directed to a rejected energy handling unit 318. Patterned energy is relayed by image relay 320 toward an article processing unit 340, in one embodiment as a two-dimensional image 322 focused near a bed 346. The article processing unit 340 can include a cartridge such as previously discussed. The article processing unit 340 has plate or bed 346 (with walls 348) that together form a sealed cartridge chamber containing material 344 (e.g. a metal powder) dispensed by powder hopper or other material dispenser 342. Dispensed powder can be created or recycled as discussed in this disclosure. Patterned energy, directed by the image relay 320, can melt, fuse, sinter, amalgamate, change crystal structure, influence stress patterns, or otherwise chemically or physically modify the dispensed and distributed material 344 to form structures with desired properties. A control processor 350 can be connected to variety of sensors, actuators, heating or cooling systems, monitors, and controllers to coordinate operation of the laser source and amplifier(s) 312, beam shaping optics 314, laser patterning unit 316, and image relay 320, as well as any other component of system 300. As will be appreciated, connections can be wired or wireless, continuous or intermittent, and include capability for feedback (for example, thermal heating can be adjusted in response to sensed temperature).

In some embodiments, beam shaping optics 314 can include a great variety of imaging optics to combine, focus, diverge, reflect, refract, homogenize, adjust intensity, adjust frequency, or otherwise shape and direct one or more laser beams received from the laser source and amplifier(s) 312 toward the laser patterning unit 316. In one embodiment, multiple light beams, each having a distinct light wavelength, can be combined using wavelength selective mirrors (e.g. dichroic) or diffractive elements. In other embodiments, multiple beams can be homogenized or combined using multifaceted mirrors, microlenses, and refractive or diffractive optical elements.

In addition to monolithic embodiments described with respect to FIGS. 1A, 1B, 2A, and 2B, a laser patterning unit 316 can include static or dynamic energy patterning elements. For example, laser beams can be blocked by masks with fixed or movable elements. To increase flexibility and ease of image patterning, pixel addressable masking, image generation, or transmission can be used. In some embodiments, the laser patterning unit includes addressable light valves, alone or in conjunction with other patterning mechanisms to provide patterning. The light valves can be transmissive, reflective, or use a combination of transmissive and reflective elements. Patterns can be dynamically modified using electrical or optical addressing. In one embodiment, a transmissive optically addressed light valve acts to rotate polarization of light passing through the valve, with optically addressed pixels forming patterns defined by a light projection source. In another embodiment, a reflective optically addressed light valve includes a write beam for modifying polarization of a read beam. In certain embodiments, non-optically addressed light valves can be used. These can include but are not limited to electrically addressable pixel elements, movable mirror or micro-mirror systems, piezo or micro-actuated optical systems, fixed or movable masks, or shields, or any other conventional system able to provide high intensity light patterning.

Rejected energy handling unit 318 is used to disperse, redirect, or utilize energy not patterned and passed through the image relay 320. In one embodiment, the rejected energy handling unit 318 can include passive or active cooling elements that remove heat from both the laser source and amplifier(s) 312 and the laser patterning unit 316. In other embodiments, the rejected energy handling unit can include a “beam dump” to absorb and convert to heat any beam energy not used in defining the laser pattern. In still other embodiments, rejected laser beam energy can be recycled using beam shaping optics 314. Alternatively, or in addition, rejected beam energy can be directed to the article processing unit 340 for heating or further patterning. In certain embodiments, rejected beam energy can be directed to additional energy patterning systems or article processing units.

In one embodiment, a “switchyard” style optical system can be used. Switchyard systems are suitable for reducing the light wasted in the additive manufacturing system as caused by rejection of unwanted light due to the pattern to be printed. A switchyard involves redirections of a complex pattern from its generation (in this case, a plane whereupon a spatial pattern is imparted to structured or unstructured beam) to its delivery through a series of switch points. Each switch point can optionally modify the spatial profile of the incident beam. The switchyard optical system may be utilized in, for example and not limited to, laser-based additive manufacturing techniques where a mask is applied to the light. Advantageously, in various embodiments in accordance with the present disclosure, the thrown-away energy may be recycled in either a homogenized form or as a patterned light that is used to maintain high power efficiency or high throughput rates. Moreover, the thrown-away energy can be recycled and reused to increase intensity to print more difficult materials.

Image relay 320 can receive a patterned image (either one or two-dimensional) from the laser patterning unit 316 directly or through a switchyard and guide it toward the article processing unit 340. In a manner similar to beam shaping optics 314, the image relay 320 can include optics to combine, focus, diverge, reflect, refract, adjust intensity, adjust frequency, or otherwise shape and direct the patterned light. Patterned light can be directed using movable mirrors, prisms, diffractive optical elements, or solid state optical systems that do not require substantial physical movement. One of a plurality of lens assemblies can be configured to provide the incident light having the magnification ratio, with the lens assemblies both a first set of optical lenses and a second sets of optical lenses, and with the second sets of optical lenses being swappable from the lens assemblies. Rotations of one or more sets of mirrors mounted on compensating gantries and a final mirror mounted on a build platform gantry can be used to direct the incident light from a precursor mirror onto a desired location. Translational movements of compensating gantries and the build platform gantry are also able to ensure that distance of the incident light from the precursor mirror the article processing unit 340 is substantially equivalent to the image distance. In effect, this enables a quick change in the optical beam delivery size and intensity across locations of a build area for different materials while ensuring high availability of the system.

The material dispenser 342 (e.g. powder hopper) in article processing unit 340 (e.g. cartridge) can distribute, remove, mix, provide gradations or changes in material type or particle size, or adjust layer thickness of material. The material can include metal, ceramic, glass, polymeric powders, other melt-able material capable of undergoing a thermally induced phase change from solid to liquid and back again, or combinations thereof. The material can further include composites of melt-able material and non-melt-able material where either or both components can be selectively targeted by the imaging relay system to melt the component that is melt-able, while either leaving along the non-melt-able material or causing it to undergo a vaporizing/destroying/combusting or otherwise destructive process. In certain embodiments, slurries, sprays, coatings, wires, strips, or sheets of materials can be used. Unwanted material can be removed for disposable or recycling by use of blowers, vacuum systems, sweeping, vibrating, shaking, tipping, or inversion of the bed 346.

In addition to material handling components, the article processing unit 340 can include components for holding and supporting 3D structures, mechanisms for heating or cooling the chamber, auxiliary or supporting optics, and sensors and control mechanisms for monitoring or adjusting material or environmental conditions. The article processing unit can, in whole or in part, support a vacuum or inert gas atmosphere to reduce unwanted chemical interactions as well as to mitigate the risks of fire or explosion (especially with reactive metals). In some embodiments, various pure or mixtures of other atmospheres can be used, including those containing Ar, He, Ne, Kr, Xe, CO₂, N₂, O₂, SF₆, CH₄, CO, N₂O, C₂H₂, C₂H₄, C₂H₆, C₃H₆, C₃H₈, i-C₄H₁₀, C₄H₁₀, 1-C₄H₈, cic-2, C₄H₇, 1,3-C₄H₆, 1,2-C₄H₆, CsH₁₂, n-CsH₁₂, i-CsH₁₂, n-C₆H₁₄, C₂H₃Cl, C₇H₁₆, C₈H₁₈, C₁₀H₂₂, C₁₁H₂₄, C₁₂H₂₆, C₁₃H₂₈, C₁₄H₃₀, C₁₅H₃₂, C₁₆H₃₄, C₆H₆, C₆H₅—CH₃, C₈H₁₀, C₂H₅OH, CH₃OH, iC₄H₈. In some embodiments, refrigerants or large inert molecules (including but not limited to sulfur hexafluoride) can be used. An enclosure atmospheric composition to have at least about 1% He by volume (or number density), along with selected percentages of inert/non-reactive gasses can be used.

In certain embodiments, a plurality of article processing units, cartridges, or build chambers, each having a build platform to hold a powder bed, can be used in conjunction with multiple optical-mechanical assemblies arranged to receive and direct the one or more incident energy beams into the cartridges. Multiple cartridges allow for concurrent printing of one or more print jobs.

In another embodiment, one or more article processing units, cartridges, or build chambers can have a cartridge that is maintained at a fixed height, while optics are vertically movable. A distance between final optics of a lens assembly and a top surface of powder bed a may be managed to be essentially constant by indexing final optics upwards, by a distance equivalent to a thickness of a powder layer, while keeping the build platform at a fixed height. Advantageously, as compared to a vertically moving the build platform, large and heavy objects can be more easily manufactured, since precise micron scale movements of the ever changing mass of the build platform are not needed. Typically, build chambers intended for metal powders with a volume more than ˜0.1-0.2 cubic meters (i.e., greater than 100-200 liters or heavier than 500-1,000 kg) will most benefit from keeping the build platform at a fixed height.

In one embodiment, a portion of the layer of the powder bed in a cartridge may be selectively melted or fused to form one or more temporary walls out of the fused portion of the layer of the powder bed to contain another portion of the layer of the powder bed on the build platform. In selected embodiments, a fluid passageway can be formed in the one or more first walls to enable improved thermal management.

In some embodiments, the additive manufacturing system can include article processing units or cartridges that supports a powder bed capable of tilting, inverting, and shaking to separate the powder bed substantially from the build platform in a hopper. The powdered material forming the powder bed may be collected in a hopper for reuse in later print jobs. The powder collecting process may be automated and vacuuming or gas jet systems also used to aid powder dislodgement and removal.

Some embodiments, the additive manufacturing system can be configured to easily handle parts longer than an available build chamber or cartridge. A continuous (long) part can be sequentially advanced in a longitudinal direction from a first zone to a second zone. In the first zone, selected granules of a granular material can be amalgamated. In the second zone, unamalgamated granules of the granular material can be removed. The first portion of the continuous part can be advanced from the second zone to a third zone, while a last portion of the continuous part is formed within the first zone and the first portion is maintained in the same position in the lateral and transverse directions that the first portion occupied within the first zone and the second zone. In effect, additive manufacture and clean-up (e.g., separation and/or reclamation of unused or unamalgamated granular material) may be performed in parallel (i.e., at the same time) at different locations or zones on a part conveyor, with no need to stop for removal of granular material and/or parts.

In another embodiment, additive manufacturing capability can be improved by use of an enclosure restricting an exchange of gaseous matter between an interior of the enclosure and an exterior of the enclosure. An airlock provides an interface between the interior and the exterior; with the interior having multiple additive manufacturing chambers, including those supporting power bed fusion. A gas management system maintains gaseous oxygen within the interior at or below a limiting oxygen concentration, increasing flexibility in types of powder and processing that can be used in the system.

In another manufacturing embodiment, capability can be improved by having a article processing units, cartridges, or build chamber contained within an enclosure, the build chamber being able to create a part having a weight greater than or equal to 2,000 kilograms. A gas management system may maintain gaseous oxygen within the enclosure at concentrations below the atmospheric level. In some embodiments, a wheeled vehicle may transport the part from inside the enclosure, through an airlock, since the airlock operates to buffer between a gaseous environment within the enclosure and a gaseous environment outside the enclosure, and to a location exterior to both the enclosure and the airlock.

Other manufacturing embodiments involve collecting powder samples in real-time from the powder bed. An ingester system is used for in-process collection and characterizations of powder samples. The collection may be performed periodically and the results of characterizations result in adjustments to the powder bed fusion process. The ingester system can optionally be used for one or more of audit, process adjustments or actions such as modifying printer parameters or verifying proper use of licensed powder materials.

Yet another improvement to an additive manufacturing process can be provided by use of a manipulator device such as a crane, lifting gantry, robot arm, or similar that allows for the manipulation of parts that can be difficult or impossible for a human to move is described. The manipulator device can grasp various permanent or temporary additively manufactured manipulation points on a part to enable repositioning or maneuvering of the part.

Control processor 350 can be connected to control any components of additive manufacturing system 300 described herein, including lasers, laser amplifiers, optics, heat control, build chambers, and manipulator devices. The control processor 350 can be connected to variety of sensors, actuators, heating or cooling systems, monitors, and controllers to coordinate operation. A wide range of sensors, including imagers, light intensity monitors, thermal, pressure, or gas sensors can be used to provide information used in control or monitoring. The control processor can be a single central controller, or alternatively, can include one or more independent control systems. The controller processor 350 is provided with an interface to allow input of manufacturing instructions. Use of a wide range of sensors allows various feedback control mechanisms that improve quality, manufacturing throughput, and energy efficiency.

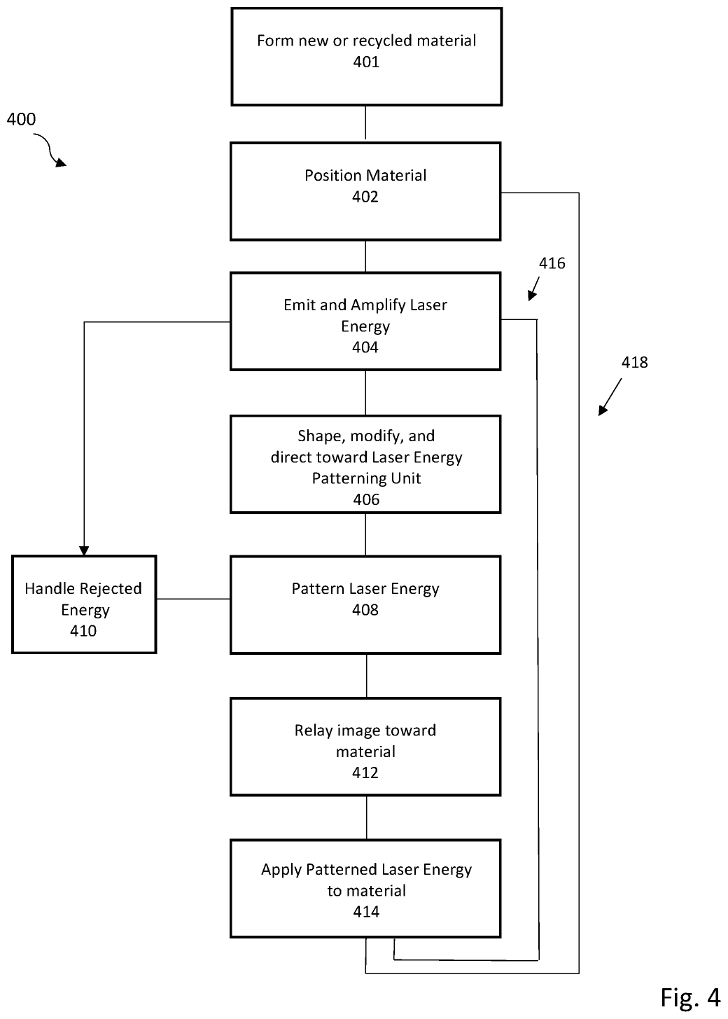

One embodiment of operation of a manufacturing system suitable for additive or subtractive manufacture is illustrated in FIG. 4. In this embodiment, a flow chart 400 illustrates one embodiment of a manufacturing process supported by the described optical and mechanical components. In step 401, material powder created or recycled as discussed in this disclosure is formed. In step 402, the powder material is positioned in a cartridge, bed, chamber, or other suitable support. In some embodiments, the material can be a metal plate for laser cutting using subtractive manufacture techniques, or a powder capable of being melted, fused, sintered, induced to change crystal structure, have stress patterns influenced, or otherwise chemically or physically modified by additive manufacturing techniques to form structures with desired properties.

In step 404, unpatterned laser energy is emitted by one or more energy emitters, including but not limited to solid state or semiconductor lasers, and then amplified by one or more laser amplifiers. In step 406, the unpatterned laser energy is shaped and modified (e.g. intensity modulated or focused). In step 408, this unpatterned laser energy is patterned, with energy not forming a part of the pattern being handled in step 410 (this can include conversion to waste heat, recycling as patterned or unpatterned energy, or waste heat generated by cooling the laser amplifiers in step 404). In step 412, the patterned energy, now forming a one or two-dimensional image is relayed toward the material. In step 414, the image is applied to the material, either subtractively processing or additively building a portion of a 3D structure. For additive manufacturing, these steps can be repeated (loop 418) until the image (or different and subsequent image) has been applied to all necessary regions of a top layer of the material. When application of energy to the top layer of the material is finished, a new layer can be applied (loop 416) to continue building the 3D structure. These process loops are continued until the 3D structure is complete, when remaining excess material can be removed or recycled.

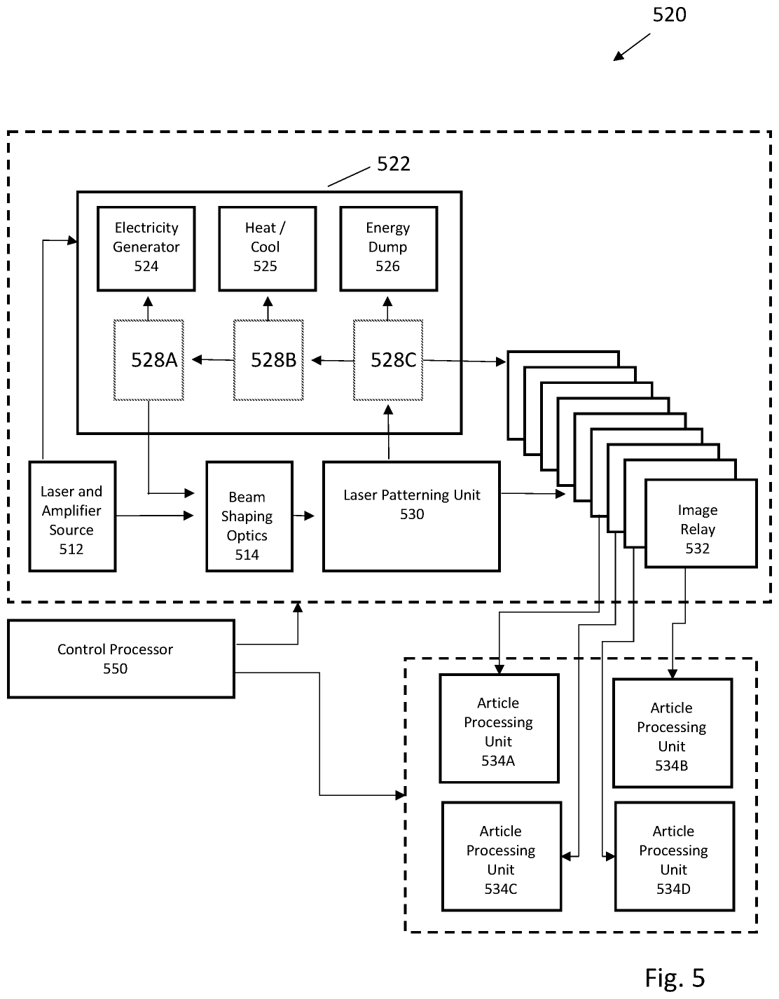

FIG. 5 is one embodiment of an additive manufacturing system that includes a phase change light valve and a switchyard system enabling reuse of patterned two-dimensional energy. An additive manufacturing system 520 has an energy patterning system with a laser and amplifier source 512 that directs one or more continuous or intermittent laser beam(s) toward beam shaping optics 514. Excess heat can be transferred into a rejected energy handling unit 522 that can include an active light valve cooling system. After shaping, the beam is two-dimensionally patterned by an energy patterning unit 530, with generally some energy being directed to the rejected energy handling unit 522. Patterned energy is relayed by one of multiple image relays 532 toward one or more article processing units 534A, 534B, 534C, or 534D, typically as a two-dimensional image focused near a movable or fixed height bed. The bed be inside a cartridge that includes a powder hopper or similar material dispenser. Patterned laser beams, directed by the image relays 532, can melt, fuse, sinter, amalgamate, change crystal structure, influence stress patterns, or otherwise chemically or physically modify the dispensed material to form structures with desired properties.

In this embodiment, the rejected energy handling unit has multiple components to permit reuse of rejected patterned energy. Coolant fluid from the laser amplifier and source 512 can be directed into one or more of an electricity generator 524, a heat/cool thermal management system 525, or an energy dump 526. Additionally, relays 528A, 528B, and 528C can respectively transfer energy to the electricity generator 524, the heat/cool thermal management system 525, or the energy dump 526. Optionally, relay 528C can direct patterned energy into the image relay 532 for further processing. In other embodiments, patterned energy can be directed by relay 528C, to relay 528B and 528A for insertion into the laser beam(s) provided by laser and amplifier source 512. Reuse of patterned images is also possible using image relay 532. Images can be redirected, inverted, mirrored, sub-patterned, or otherwise transformed for distribution to one or more article processing units 534A-D. Advantageously, reuse of the patterned light can improve energy efficiency of the additive manufacturing process, and in some cases improve energy intensity directed at a bed or reduce manufacture time.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

1. A print engine of an additive manufacturing system, comprising
an XY galvo arranged to direct a laser beam toward multiple positions on a print bed following a print path;
an XY gantry supporting the XY galvo; and
a motion control system for the XY gantry and XY galvo that supports dynamic adjustment of cycle time.

2. The print engine of the additive manufacturing system of claim 1, further comprising a laser able to direct a two dimensional laser image against the print bed.

3. The print engine of the additive manufacturing system of claim 1, wherein the print bed is a powder bed.

4. The print engine of the additive manufacturing system of claim 1, wherein the print path is defined at least in part according to a pattern that is to be printed.

5. The print engine of the additive manufacturing system of claim 1, wherein the print path is at least in part serpentine.

6. A print engine of an additive manufacturing system, comprising
an XY galvo arranged to direct a laser beam toward multiple positions on a print bed;
an XY gantry supporting the XY galvo; and
a motion control system for the XY gantry and XY galvo that controls movement to provide a serpentine pattern over tiles having patterns to be printed.

7. The print engine of the additive manufacturing system of claim 6, further comprising a laser able to direct a two dimensional laser image against the print bed.

8. The print engine of the additive manufacturing system of claim 6, wherein the print bed is a powder bed.

9. A print engine of an additive manufacturing system, comprising
an XY galvo arranged to direct a laser beam toward multiple positions on a print bed;
an XY gantry supporting the XY galvo; and
a motion control system for the XY gantry and XY galvo that controls movement to provide offset printing of tiles between layers.

10. The print engine of the additive manufacturing system of claim 9, further comprising a laser able to direct a two dimensional laser image against the print bed.

11. The print engine of the additive manufacturing system of claim 9, wherein the print bed is a powder bed.

12. A print engine of an additive manufacturing system, comprising
an XY gantry
an XY galvo supported by the XY gantry, with the XY galvo arranged to direct a two dimensional laser beam toward multiple tiles defined as positions on a print bed according to a defined print path.

13. The print engine of the additive manufacturing system of claim 9, further comprising a motion control system for the XY gantry and XY galvo that supports dynamic adjustment of cycle time.

14. The print engine of the additive manufacturing system of claim 9, wherein the print bed is a powder bed.
